(19) United States
(12) Patent Application Publication
(10) Pub. No.: US 2007/0134535 A1
(43) Pub. Date: Jun. 14, 2007

(54) Separating plate for polymer electrolyte membrane fuel cell and method for manufacturing the same

(75) Inventors: Min-Kyu Song, Seoul (KR); Yoo Chang Yang, Gyeonggi-do (KR); Kyung Sup Han, Gyeongsangbuk-do (KR); Sung Il Huh, Gyeongsangbuk-do (KR); Tae Won Lim, Seoul (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/494,021

(22) Filed: Jul. 26, 2006

(30) Foreign Application Priority Data
Dec. 8, 2005 (KR) 10-2005-0119198

(51) Int. Cl. H01M 8/02; H01B 1/24; B32B 9/00; B29C 69/00; C08J 5/00

(52) U.S. Cl. 429/34; 428/408; 252/511; 264/241; 264/331.11

(57) ABSTRACT

A separating plate for polymer electrolyte membrane fuel cell and a method for manufacturing the same is provided. Preferred separating plates for polymer electrolyte membrane fuel cell are capable of being light weight and corrosion resistant, as well as being economical to produce and exhibit good physical properties. Preferred separating plates are produced with compositions comprising graphite and phenolic resin.

### CROSS-REFERENCE TO RELATED APPLICATIONS

This application claims the benefit of Korean Patent Application No. 10-2005-0119198, filed on Dec. 8, 2005, in the Korean Intellectual Property Office, the disclosure of which is incorporated herein by reference.

### BACKGROUND

1. Field of the Invention

The present invention relates to, inter alia, a separating plate for a polymer electrolyte membrane fuel cell and a method for manufacturing the same.

2. Discussion of Related Art

Generally, a polymer electrolyte membrane fuel cell (hereinafter, referred to as ‘PEMFC’) refers to a fuel cell that uses a polymer membrane as an electrolyte, which has a hydrogen ion exchange property. The PEMFC is an energy conversion apparatus for directly converting chemical energy into electric energy without combustion via an electrochemical reaction of hydrogen and oxygen as a fuel.

A basic structure of the PEMFC is as follows: a polymer electrolyte membrane is arranged in its central region; porous cathode and anode coated with a precious metal catalyst are disposed in both sides of the polymer electrolyte membrane; and a separating plate for supplying a fuel is arranged outside of the electrodes.

The separating plate can serve to structurally support the fuel cells, to supply a fuel to a membrane electrode assembly, to remove moisture generated during operation of the fuel cells, and to gather the generated electricity, as well as to control temperature by supplying a cooling water through a cooling passage formed in the inside thereof; and/or to remove the heat generated during the operation of the fuel cells.

A generally preferred material to form a separating plate is pure graphite, which can provide desired properties, such as electric conductivity and corrosion resistance.

However, pure graphite also can impart disadvantages including significant expense and burdensome mass-production due to required mechanical processing to form passages. Additionally, graphite can be porous, and to impart an air-sealed system, an additional resin impregnation process can be required after completing initial fabrication processing.

Pure graphite also can be brittle. Additionally, the formed graphite element can be required to have a constant thickness so as to prevent reactive gas from being mixed with fuel cell components.

Certain attempts have been made to address such problems associated with such a pure graphite separating plate. In particular, efforts have been made to fabricate the separating plate with metals.

If metals are used as the separating plate, then the thickness and cost of the separating plate may be reduced relative to pure graphite. On the other hand, however, a metal separating plate may corrode over operational life due to lower corrosion resistance, and performance of the PEMFC may be deteriorated as metal ions can penetrate into a polymer membrane to interrupt movement of hydrogen ions, particularly if corrosion develops in the separating plate.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

In one aspect, a separating plate is provided for a polymer electrolyte membrane fuel cell, where the separating plate is capable of being light weight and resistant to corrosion, as well as being relatively economical with enhanced physical properties. In preferred aspects, such separating plates of the invention may be provided by processes which comprise uniformly loading the material, shortened molding time, removing bubbles which may be generated upon molding and/or a subsequent heat-treating process. In additional preferred aspects, a separating plate manufacturing process is provided using a composite material where a polymer is added to graphite by using an extrusion molding process.

In one preferred embodiment, a separating plate for polymer electrolyte membrane fuel cell is provided, where the separating plate comprises graphite and phenol resin. The separating plate composition also may suitably comprise other materials in addition to graphite and phenol resin such as a curing agent. In particularly preferred aspects, the separating plate composition may comprise graphite, phenol resin and curing agent in amounts of 75 to 85 % by weight of graphite having a mean particle size of 10 to 200 μm, 13.5 to 22.5 % by weight of phenol resin and 1.5 to 2.5 % by weight of a curing agent, where such weight percents are based on total weight of the graphite/phenol resin/curing agent admixture.

Further, in additional aspects, methods for manufacturing a separating plate for polymer electrolyte membrane fuel cell are provided, the methods comprising: mixing graphite, phenol resin and optionally a curing agent which may, in preferred aspects, be present in amounts of 75 to 85% by weight of graphite having a mean particle size of 10 to 200 μm, 13.5 to 22.5% by weight of phenol resin and 1.5 to 2.5% by weight of a curing agent (where such weight percents are based on total weight of the graphite/phenol resin/curing agent admixture); dispersing the mixture in a mold; molding the dispersed mixture in the mold; and heat-treating the molded mixture e.g. at 100 to 120° C.

In a preferred aspect, the mold is processed to be round in its corner (i.e. has one or more rounded corners). Such rounded corner(s) suitably may prevent stress from converging to a corner of the separating plate channel.

The dispersion process of the mixture may be include mounting a side mold in a lower mold; uniformly dispersing the loaded mixture with a constant height in the mold by scattering the graphite/phenol mixture in the mold and reciprocating a spreader; inserting a predetermined size of a spacer into a lower portion of the side mold; and mounting an upper mold on the mixture.

It is preferable that the molding process of the mixture is pressed at a pressure of 800 to 2000 psi and a temperature of 100 to 200° C., wherein the molding process is maintained at a low pressure in an early stage.

The molding process of the mixture may be include a pre-heating step of heating to 100 to 200° C. and maintaining the temperature for a time sufficient to melt the mixture; a pre-pressing step e.g. of applying a pressure of 300 to 700 psi for less than 5, 4, 3, 2, or 1 minutes such as about 30 seconds; a depressurizing step of removing the pressure; and a molding step of molding the mixture so that bubbles present in the mixture can escape from the mold, e.g. the molding step can be performed at a pressure of 800 to 2000 psi.

The invention also includes fuel cells that comprise one or more of the disclosed separating plates. Preferably, the fuel cells are polymer electrolyte membrane fuel cells.

Other aspects of the invention are discussed below.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a schematic view showing a method for manufacturing a separating plate for polymer electrolyte membrane fuel cell according to the present invention;

FIG. 2 is a schematic view showing a molding process according to the present invention;

FIG. 3 is a diagram showing a process for removing bubbles according to the present invention;

FIG. 4 is an image showing a sectional diagram of a channel according to the present invention;

FIG. 5 is a plane view showing positions of test pieces for measuring density and electric conductivity;

FIG. 6 is a diagram showing a density distribution according to positions of test pieces according to the present invention;

FIG. 7 is a diagram showing a density distribution according to positions of test pieces according to the present invention;

FIG. 8 is a schematic view showing a conventional direct dispersion method in the method for manufacturing a separating plate for polymer electrolyte membrane fuel cell according to the prior art;

FIG. 9 is a schematic view showing a stamping process in the method for manufacturing a separating plate for polymer electrolyte membrane fuel cell according to the prior art;

FIG. 10 is a diagram showing a conventional molding process; and

FIG. 11 is an image showing surface delamination owing to generation of bubbles.

### DETAILED DESCRIPTION

In one preferred aspect, a fuel cell is provided, where the fuel separating plate comprises graphite and phenol resin. The separating plate composition suitably may comprise additional materials such as a curing agent. Preferably, the graphite is present in an amount of 75 to 85% by weight suitably where the graphite has a mean particle size of 10 to 200 μm. Preferably, the phenol resin is present in an amount of 13.5 to 22.5% by weight. Preferably, the curing agent if employed is present in an amount 1.5 to 2.5% by weight. Suitably, those weight percents of graphite, phenol resin and curing agent are based on total weight of the admixture of those graphite/phenol resin/curing agent components.

Hereinafter, preferred embodiments according to the present invention will be described in detail with reference to the accompanying drawings.

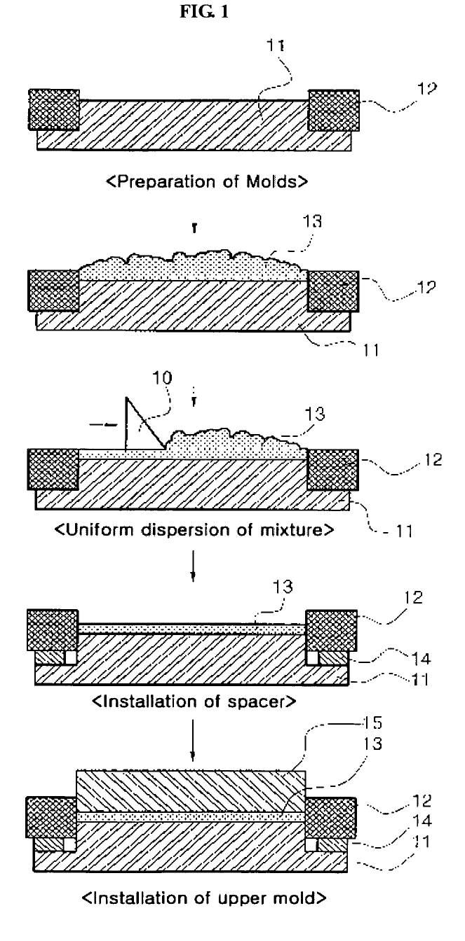

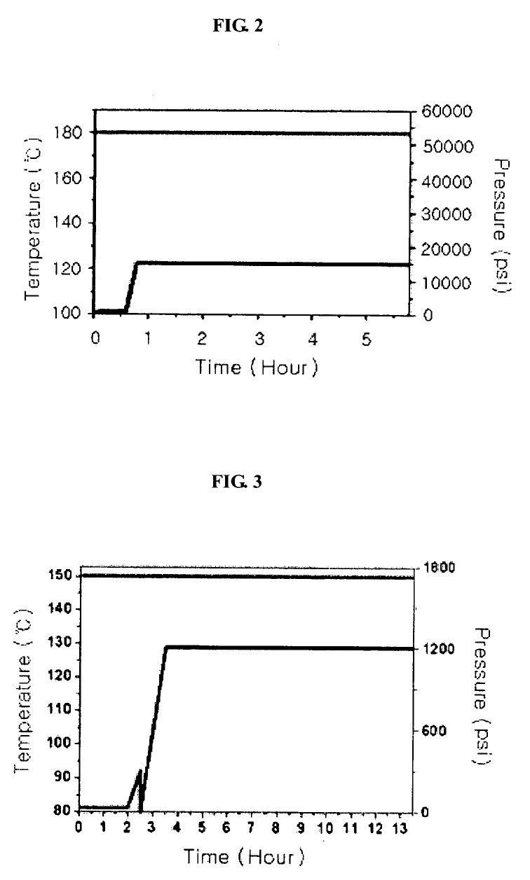

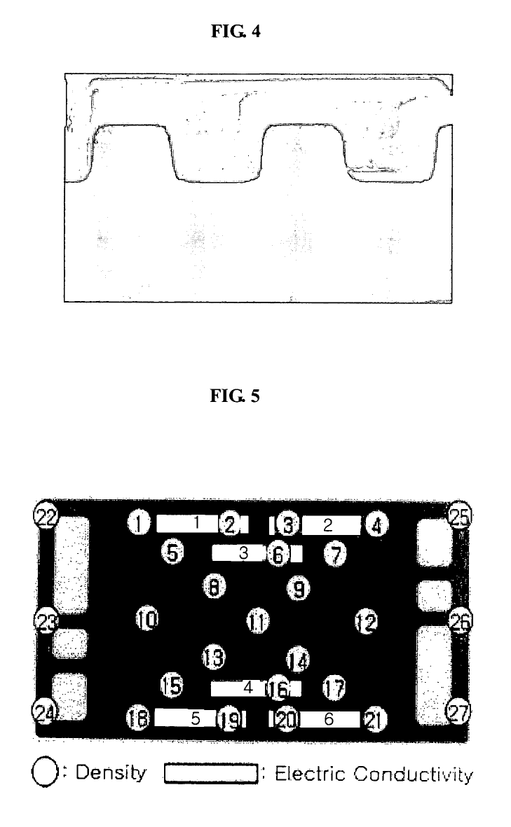

FIG. 1 is a schematic view showing a preferred method for manufacturing a preferred separating plate for polymer electrolyte membrane fuel cell according to the present invention; FIG. 2 is a diagram showing a molding process according to the present invention; FIG. 3 is a diagram showing a process for removing bubbles according to the present invention; and FIG. 4 is an image showing a sectional diagram of a channel according to the present invention.

The present invention relates to a polymer electrolyte separating plate for electrolyte membrane fuel cell and a method for manufacturing the same using a compression molding process.

In one aspect, the present invention includes a separating plate that can be manufactured using a composite material, in a more economical manner with good physical properties. In preferred systems, processes are employed to uniformly load material using a spreader 10, and use of a shortened molding time which can including employing a relatively low pressure during early processing stages, as well as a process of removing bubbles which may be generated upon molding. Such bubble remove is preferably accomplished through use of a fluctuating pressure process. A subsequent heat-treating process also may be employed.

Particularly preferred compositions and contents of the separating plate for polymer electrolyte membrane fuel cell according to the present invention may include the following:

1) Graphite (preferably, having a mean particle size of about 10 to 200 μm): preferably in amount of 75 to 85% by weight.

The graphite can provide good physical properties such as electric conductivity and corrosion resistance, and preferably has a particle size of 10 to 200 μm. In particular, it may be difficult to achieve a high electric conductivity if the particle size of the graphite is less than 10 μm, while mechanical strength potentially may be compromised if the particle size significantly exceeds 200 μm.

Also, the graphite is preferably used in an amount of 75 to 85% by weight. Reduced corrosion resistance may be seen if appreciably less than 75% by weight of graphite is employed, while processability may deteriorate due to an increased brittleness if graphite content exceeds 85% by weight.

2) Phenol resin: preferably in amounts of 13.5 to 22.5% by weight.

The phenol resin is suitably employed to enhance mechanical process upon producing a cooling passage in the inside of the separating plate. Preferably, the phenol resin component is employed at an amount of 13.5 to 22.5% by weight since processability can deteriorate the phenol resins content is less than 13.5% by weight, while an undesirable hardness may result if the phenol resin content exceeds 22.5% by weight. A variety of phenol resins may be utilized such as novolak resins, poly(vinylphenol) resins and others. The phenol resin also may have a variety of molecular weights, such as a weight average molecular weight of from 500 or 1000 to 10,000 or greater such as in excess of 100,000.

3) Curing agent (e.g., amine or nitrogen-containing agent such as hexamethylenetetramine): preferably used in 1.5 to 2.5% by weight.

The curing agent is suitably added to control a curing level of a phenol resin, and preferably is is added at an amount of 1.5 to 2.5% by weight based on weight of the graphite, phenolic resin and curing agent composition. Reduced hardness may occur if the curing agent content is present in amounts less than 1.5% by weight, while increased brittleness may occur if the curing agent exceeds 2.5% by weight. In certain particularly preferred compositions, the phenol resin and curing agent are employed in weight ratios of phenolic resin:curing agent of about 9: 1. A variety of curing agents may be employed including polyamines and nitrogen-containing resins such as melamine resins.

A preferred manufacturing process to produce a separating plate for polymer electrolyte membrane fuel cell according can be divided into three steps: 1) a step of mixing graphite and phenol resin powder, 2) a step of dispersing a mixture, and 3) a step of molding a dispersion.

1) In a specifically preferred embodiment, graphite powder and polymer are prepared at a compositional ratio, added to a vessel, and then shaken such as for less than one hour e.g. 30 minutes. The polymer employed may include phenol resin, epoxy resin, vinyl ester resin, polypropylene resin, polyvinyldifluoride resin (PVDF), polyphenylenesulfide (PPS) resin, etc., and the phenol resin is preferably used either as the sole resin or in combination with other resins.

2) A dispersion process is carried out when the graphite/polymer mixture is prepared, as follows in certain specifically preferred embodiments:

Preparation of a mold: a side mold 12 is mounted in a lower mold 11. At this time, the lower mold 11 becomes flatter in the remaining region except an installation unit of the side mold 12.

Uniform dispersion of the graphite/phenol resin mixture 13: the prepared graphite/polymer mixture 13 is scattered in the mold, and the graphite/phenol resin mixture 13 is uniformly dispersed with a constant height in the given space of the lower mold 11 by reciprocating a spreader 10.

Installation of a spacer 14: a side mold 12 is raised using spacer 14 manufactured to be suitable for a desired thickness of the molded product.

The thickness of the composite separating plate, manufactured by the extrusion molding process, suitably can be varied according to a loading amount of materials, and therefore the thickness of materials can be determined by controlling an amount of a mixture added into a mold in the conventional methods.

In prior approaches, it can be difficult to control the thickness of the separating plate due to inaccurate or varying amounts of the added mixture. In order to solve the problems, preferred systems of the present invention provide a spacer 14 capable of controlling the loading height in the lower mold 11 in itself.

The loading height of the graphite/phenol mixture 13 is varied according to the loading ratio of the graphite powder, types and sizes of the particles. Therefore the desired loading height can be secured by changing the height of the spacer 14 according to the conditions.

Meanwhile, it can be important to uniformly manufacture the composite separating plate according to its position to achieve optimal performance properties.

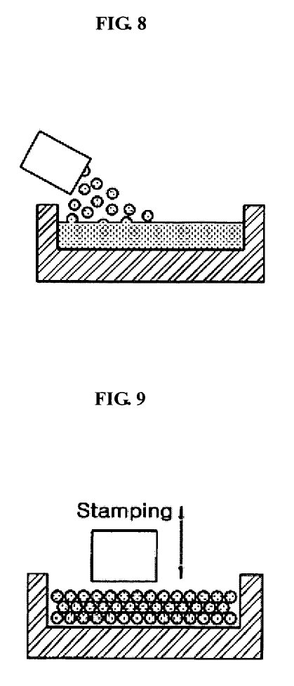

However, conventional direct dispersion methods have a disadvantage that it is difficult to apply to fuel cells because of highly large density difference according to their position, as shown in FIG. 8.

In order to solve such problems, a method for enhancing uniformity prior to molding using a stamping process as shown in FIG. 9 was evaluated, but such a stamping method did not provide significant improvements relative to direct dispersion methods and can provide for a more complex manufacturing process.

To address such problems, a uniform loading mechanism using a spreader 10 was developed.

That is, a uniform density may be maintained regardless of their position if a large amount of the graphite/phenol mixture 13 is previously added into the mold, and then a loading height is adjusted using a spreader 10.

Installation of upper mold 15: an upper mold 15 is put on the graphite/phenol mixture 13 uniformly dispersed by the spreader 10.

Average density and standard deviation of the composite separating plate, manufactured using the conventional dispersion method and a preferred spreader/dispersion method of the present invention are listed in the following Table 1.

TABLE 1

| | Average Density | Standard Deviation |
|---|---|---|
| | (g/cm³) | (g/cm³) |
| Conventional | 1.903 | 0.114 |
| Dispersion | | |
| Dispersion of the | 1.921 | 0.048 |
| Present invention | | |

As seen in Table 1, it was confirmed that the standard deviation was reduced from 0.114 g/cm³ to 0.048 g/cm³, and the own average density was increased from 1.903 g/cm³ to 1.921 g/cm³.

3) The separating plates were subject to the dispersion process, and then molded at a high temperature and a high pressure.

The molding time also can be shortened to facilitate mass-producing high quality composite separating plates.

Phenol resins have been useful to shorten the molding time. Other materials such as epoxy resins may be less useful.

Particularly preferred phenol resins may have a melting point of about 90° C., and may be generally cured at 150° C. for 1 minute. Such curing conditions may be effective for the phenol resin itself. If the phenol resin is admixed with graphite (e.g. 80% by weight graphite admixed thereto), more vigorous (e.g. higher temperature and/or longer duration) may be needed.

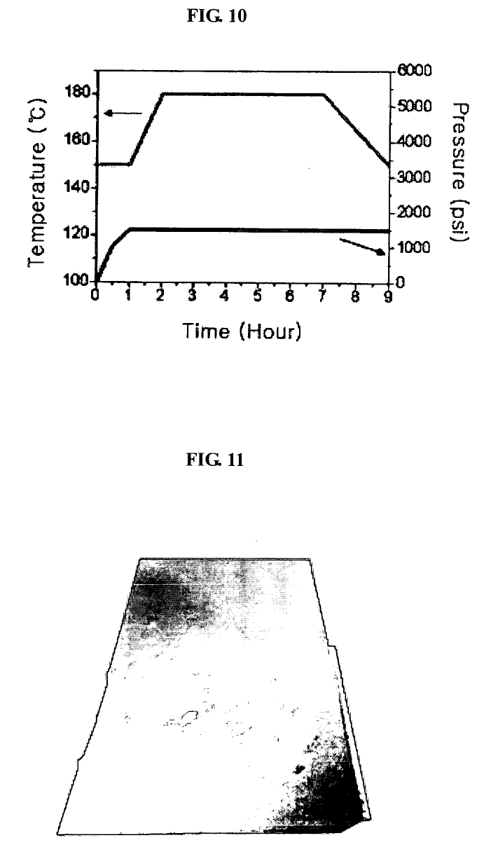

Also, it can be difficult to reduce a time required for the molding process, for example for a process for elevating the temperature for pre-heating, and a cooling process for removing the residual stress in the case of the conventional molding process, as shown in FIG. 10.

Accordingly, in preferred systems of the present invention, the need for elevating temperature can be avoided by providing the time for maintaining a relatively low pressure early in the processing through changes of the pressure that is relatively easy to be controlled. As shown in FIG. 2, a temperature line according to the time is distributed in an upper region on the graph, and a pressure line is distributed in a lower region on the graph. The molding pressure is suitably at least about 800 psi and ranges preferably from 800 to 2000 psi. Use of pressures less than 800 psi may deteriorate physical properties of the separating plate such as electric conductivity, mechanical strength, etc. Use of pressures in excess of about 2000 psi often does not provide further improved physical properties.

Also, in preferred systems of the invention, the cooling process may be omitted through use of a method for removing twist of the molded separating plate through heat-treatment of the molded separating plate. The molding time may be significantly reduced by maintaining temperature of a hot press constant by simplification of such a molding temperature/process.

At this time, the molding temperature ranges preferably from 100 to 200° C. since the molding time becomes significantly extended if the molding temperature is less than 100° C., while preferred phenol resins may be deteriorated if the molding temperature exceeds 200° C. Additionally, the mold maintenance time is suitably at least about 5 minutes and ranges preferably from 5 to 15 minutes. Separating plate physical properties such as electric conductivity, mechanical strength, etc. may be compromised if its mold maintenance time is less than 5 minutes. On the other hand, further improved physical properties may not be realized if the mold maintenance time exceeds 15 minutes.

As indicated above, bubbles may be generated in the separating plate because of water vapor generated when air, which is present among powder, or moisture, which is included in the phenol, evaporates in a step of pressing and heating the graphite/phenol mixture in the compression molding process.

If such bubble generation occurs to significant extents, the separating plate may consequently exhibit defects such as an unevenness in its surface because the bubbles generated in the inside of the separating plate are maintained therein and then expand when the molding pressure is removed, as shown in FIG. 11.

Such a phenomenon commonly appears as the pressure is increased, and frequently appears when the graphite has a plate shape, compared to a spherical shape, indicating that this is a defect that occurs due to the bubbles being unable to escape as the pressure progresses rapidly and to higher levels.

Attempts to remove bubbles by simply increasing the pressure are not particularly effective. Accordingly, in preferred systems of the invention, a fluctuating (varying) pressure process is employed so as to suppress such generation of the bubbles, as shown in FIG. 3. Thus, a fluctuating pressure process indicates that the pressure increases and decreases (e.g. by at least about 25, 50, 100 or 200 psi) one or more times during the process cycle.

That is, the temperature is increased to 100 to 200° C., which corresponds to the molding temperature, and maintained for a time sufficient to melt the graphite/phenol mixture 13 e.g. for about 2 minutes, and then the bubbles present within the materials are induced so that they can escape from the mold by increasing the molding pressure to 800 to 2000 psi immediately after the pressure is applied at 300 to 700 psi for 30 seconds.

In the separating plate manufactured using the fluctuating pressure process, it could be confirmed that the bubbles were generated at reduced levels.

Meanwhile, residual thermal stress may be generated in the materials since the composite separating plate is molded at a high temperature, or the whole plate may be twisted by an external force applied when the separating plate is demolded from the mold after molding.

The twist of the separating plate should be addressed or corrected since it can result in a critical defect upon contracting stack.

Attempts to remove the twist by employing a cooling process have not be consistently successful.

Accordingly, in preferred systems of the present invention, a heat treatment process for removing such a twist is employed. According to such preferred systems of the present invention, it can be convenient to to remove the twist using the further heat treatment after demolding since the entire molding time is short and phenol component of the separating plate may not be completely cured.

Such a heat treatment may be carried out at e.g. at least about 80° C. or 100° C. such as 100 to 120° C. for 1 hour, and the separating plate can be horizontally maintained at a low pressure of about 100 psi. Additionally, overall manufacturing times are not significantly extended by this heat treatment step as a plurality of the separating plates may be heat treated at the same time.

Hereinafter, the present invention will be described in detail in the basis of the following example, but is not limited thereto.

### EXAMPLE

In the present invention,

A graphite/phenol mixture 13, including 80% by weight of graphite having a particle size of 25 μm, 18% by weight of phenol resin and 2% by weight of a curing agent, was dispersed in a mold using a spreader 10, and then a molding process was maintained at a pressure of 1500 psi and a temperature of 150° C. for 10 minutes.

Subsequently, the temperature was increased to 150° C. and maintained for 2 minutes to melt the graphite/phenol mixture 13, and then the bubbles were induced so that they could escape from the mold by increasing the molding pressure to 1200 psi immediately after the pressure is applied at 300 psi for 30 seconds.

Finally, the separating plate was heat treated at 100° C. and 100 psi for 1 hour while being horizontally maintained so as to remove the residual thermal stress and the twist of the separating plate.

Development of Sectional Shape of Optimal Channel

The molding and demolding properties were compared and analyzed by employing various draft angles of 45°, 27° and 12°. It was shown that the manufacturing state was all good in the three draft angles, the demolding progressed smoothly, the bubbles did not appear in the inside of the channel, and the desired shape of the channel was also molded as shown in FIG. 4.

The draft angle was determined to be 10° upon applying to the large-size composite separating plate, considering the aforementioned results and the mechanical stability.

Also, the mold is processed to be round in its corner to prevent stress from converging to a corner of the channel.

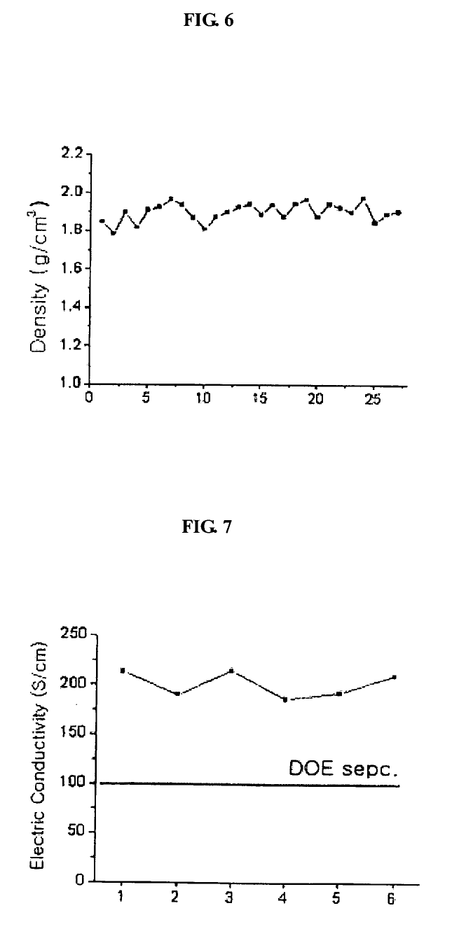

FIG. 5 is a plane view showing positions of test pieces for measuring density and electric conductivity; FIG. 6 is a diagram showing a density distribution according to positions of test pieces according to the present invention; and FIG. 7 is a diagram showing a density distribution according to positions of test pieces of the present invention.

As shown in FIG. 5, test pieces were prepared in 27 points of the separating plate to measure density of the composite separating plate molded using the manufacturing method of the present invention. And, it was seen that the density distribution according to positions of the test pieces ranged from 1.75 to 2.0 g/cm³, the average density was 1.9 g/cm³, and the standard deviation was 0.048 g/cm³, indicating that the density distribution according to their positions is good, as shown in FIG. 6.

Test pieces for measuring electric conductivity were prepared in 6 points of the separating plate, as shown in FIG. 5. And, it was seen that the electric conductivity according to positions of the test pieces ranged from 180 to 220 S/cm, the average electric conductivity was 200 S/cm, and the standard deviation was 12.9 S/cm, as shown in FIG. 7.

Thus, preferred separating plates according to the present invention may be light weight in its parts and resistant to corrosion, as well as being more economical to produce and have excellent physical properties which may result in part to a process of uniformly loading the material using a spreader 10, shortened molding time by means of simplification of a molding temperature/process, a process of removing bubbles which may be generated upon molding using a fluctuating pressure process, and/or a subsequent heat-treating process by manufacturing the separating plate using the composite materials which in certain preferred aspects include 75 to 85% by weight of graphite having a mean particle size of 10 to 200 μm, 13.5 to 22.5% by weight of phenol resin and 1.5 to 2.5% by weight of a curing agent by using an extrusion molding process. Such weight percents are based on total weight of the composite materials (e.g. total weight of admixture of graphite, phenol resin and curing agent).

As described above, to address problems associated with use of conventional pure graphite, the separating plate for polymer electrolyte membrane fuel cell and the method for manufacturing the same of the present invention have advantages that it may be light weight in its parts and corrosion resistant, as well as being more economical and more excellent in physical properties due to a process of uniformly loading the material using a spreader, shortened molding time by means of simplification of a molding temperature/process, a process of removing bubbles which may be generated upon molding using a fluctuating pressure process, and a subsequent heat-treating process by manufacturing the separating plate using the composite materials including in particularly preferred aspects 75 to 85% by weight of graphite having a mean particle size of 10 to 200 μm, 13.5 to 22.5% by weight of phenol resin and 1.5 to 2.5% by weight of a curing agent by using the extrusion molding process.

The invention has been described in detail with reference to preferred embodiments thereof. However, it will be appreciated that those skilled in the art, upon consideration of the disclosure, may make modifications and improvements within the scope and spirit of the invention.

What is claimed is:

1. A separating plate for polymer electrolyte membrane fuel cell comprising 75 to 85% by weight of graphite having a mean particle size of 10 to 200 .u n, 13.5 to 22.5% by weight of phenol resin, and 1.5 to 2.5% by weight of a curing agent.

2. A method for manufacturing a separating plate for polymer electrolyte membrane fuel cell, comprising:
mixing 75 to 85% by weight of graphite having a mean particle size of 10 to 200 μm, 13.5 to 22.5% by weight of phenol resin and 1.5 to 2.5% by weight of a curing agent;
dispersing the mixture in a mold;
molding the dispersed mixture in the mold; and
heat-treating the molded mixture at 100 to 120° C.

3. The method for manufacturing a separating plate for polymer electrolyte membrane fuel cell according to claim 2, wherein the mold is processed to be round in its corner.

4. The method for manufacturing a separating plate for polymer electrolyte membrane fuel cell according to claim 2, wherein the dispersion process of the mixture comprises:
mounting a side mold in a lower mold;
uniformly dispersing the loaded mixture with a constant height in the mold by scattering the graphite/phenol mixture in the mold and reciprocating a spreader;
inserting a predetermined size of a spacer into a lower portion of the side mold; and
mounting an upper mold on the mixture.

5. The method for manufacturing a separating plate for polymer electrolyte membrane fuel cell according to claim 2, wherein the molding process of the mixture is pressed at a pressure of 800 to 2000 psi and a temperature of 100 to 200° C., wherein the molding process is maintained at a low pressure in an early stage.

6. The method for manufacturing a separating plate for polymer electrolyte membrane fuel cell according to claim 2, wherein the molding process of the mixture comprises:
a pre-heating step of heating to 100 to 200° C. and maintaining the temperature to melt the mixture;
a pre-pressing step of applying a pressure of 300 to 700 psi;
a depressurizing step of removing off the pressure; and
a molding step of molding the mixture at a pressure of 800 to 2000 psi so that bubbles present in the mixture can withdraw from slip out of the mold.

7. The method for manufacturing a separating plate for polymer electrolyte membrane fuel cell according to claim 5, wherein the molding process of the mixture comprises:
a pre-heating step of heating to 100 to 200° C. and maintaining the temperature for 2 minutes to melt the mixture;
a pre-pressing step of applying a pressure of 300 to 700 psi for 30 seconds;
a depressurizing step of removing off the pressure; and
a molding step of molding the mixture at a pressure of 800 to 2000 psi so that bubbles present in the mixture can slip out of the mold.

8. A fuel cell comprising a separating plate of claim 1.

9. A separating plate for polymer electrolyte membrane fuel cell comprising graphite and phenolic resin.

10. The separating plate of claim 9 further comprising curing agent.

11. The separating plate of claim 9 wherein the graphite has a mean particle size of 10 to 200 μm.

12. The separating plate of claim 9 wherein the graphite is present in an amount of 75 to 85% by weight of graphite, 13.5 to 22.5% by weight of phenol resin, and 1.5 to 2.5% by weight of a curing agent.

13. The separating plate of claim 9 wherein the curing agent is a nitrogen-containing compound.

14. A fuel cell comprising the separating plate of claim 9.

15. A method for manufacturing a separating plate for polymer electrolyte membrane fuel cell, comprising:
mixing materials comprising graphite and phenol resin;
dispersing the mixture in a mold;
molding the dispersed mixture in the mold; and
heat-treating the molded mixture.

16. The method of claim 16 wherein a curing agent is mixed with graphite and phenol resin.

17. The method for manufacturing a separating plate for polymer electrolyte membrane fuel cell according to claim 15, wherein the mold is processed to be round in its corner.

18. The method for manufacturing a separating plate for polymer electrolyte membrane fuel cell according to claim 15, wherein the dispersion process of the mixture comprises:
mounting a side mold in a lower mold;
dispersing the loaded mixture with a constant height in the mold by scattering the graphite/phenol mixture in the mold and reciprocating a spreader;
inserting a predetermined size of a spacer into a lower portion of the side mold; and
mounting an upper mold on the mixture.

18. The method for manufacturing a separating plate for polymer electrolyte membrane fuel cell according to claim 15, wherein the molding process of the mixture is pressed at a pressure of 800 to 2000 psi and a temperature of 100 to 200° C.

19. The method for manufacturing a separating plate for polymer electrolyte membrane fuel cell according to claim 15 wherein the molding process of the mixture comprises:
heating to melt the mixture;
applying a pressure;
molding the mixture at an elevated pressure whereby bubbles present in the mixture can escape from the mold.
